(19) United States
(12) Patent Application Publication
(10) Pub. No.: US 2004/0064306 A1
(43) Pub. Date: Apr. 1, 2004

(54) Voice activated music playback system

(76) Inventors: Peter P. Wolf, Winchester, MA (US); Michael A. Casey, Cambridge, MA (US)

Correspondence Address: Patent Department, Mitsubishi Electric Research Laboratories, Inc., 201 Broadway, Cambridge, MA, 02139, US

(21) Appl. No.: 10/260,477

(22) Filed: Sep. 30, 2002

(51) Int. Cl. G10L 19/00

(52) U.S. Cl. 704/201

(57) ABSTRACT

A method selects recordings stored in a database. A spoken query is represented as a phonetic lattice and paths through the phonetic lattice are converted to a set of text queries. The database is searched to generate a playlist of recordings matching the set of text queries and samples of the recordings on the playlist are then played. A particular sample is selected as an acoustic query for searching the database to update the playlist with recording matching the acoustic query. Samples of the recordings on the updated playlist are played and a particular sample of the updated play list is selected. A particular record associated with the sample is then played.

### FIELD OF THE INVENTION

The present invention relates generally to searching and retrieving audio content, and more particularly to retrieving recorded music in a database using spoken queries.

### BACKGROUND OF THE INVENTION

With the advent of advanced digital compression techniques and high capacity memories, it is now possible to store very large music libraries in very small devices. Media playback devices can store thousands of music tracks. Traditional interfaces, where the user must manually select the desired recording media, as well as specific “tracks” do not work for such devices, particularly if the user is engaged in other activities while listening. In addition, the modern music library can be collected in an ad hoc manner which may even make it impossible for a user to know exactly what is stored in the library.

Some prior art methods for enabling a user to access music in a database include voice recognition technology, but the results are limited to only specific sound tracks, or files containing sound tracks manually ordered by the user, see, e.g. “How to use and enjoy your MXP 100,” e.Digital Corporation, 2001.

Therefore, new means for organizing and accessing recordings stored in a large music library need to be provided.

### SUMMARY OF THE INVENTION

The invention provides a method and system for selecting recordings stored in a database. A spoken query is represented as a phonetic lattice and paths through the phonetic lattice are converted into a set of text queries. The database is searched to generate a playlist of recordings matching the set of text queries and samples of the recordings on the playlist are then played. A particular sample is selected as an acoustic query for searching the database to update the playlist with recording matching the acoustic query. Samples of the recordings on the updated playlist are played and a particular sample of the updated play list is selected. A particular record associated with the sample then played.

### BRIEF DESCRIPTION OF THE DRAWINGS

FIG. 1 is a voice activated music playback system according to the invention; and

FIG. 2 is a flow diagram for searching and retrieving sound recordings according to the invention.

### DETAILED DESCRIPTION OF THE PREFERRED EMBODIMENT

System Structure

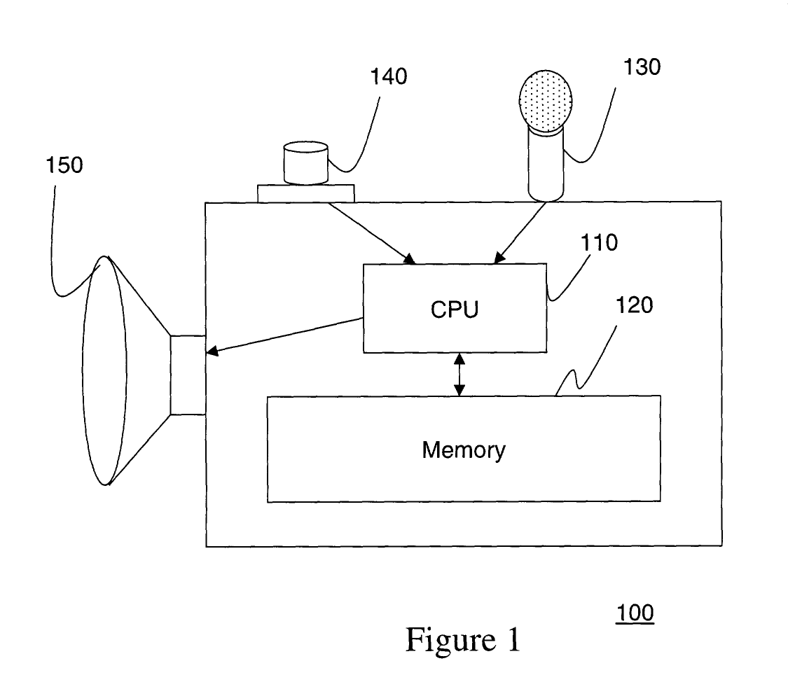

FIG. 1 shows the music playback system 100 according to the invention. The system includes a processor 110, a memory 120, a microphone 130, a switch 140 and one or more speakers 150 connected to each other.

The processor 110 is substantially conventional, executing software programs stored in the memory 120. The processor includes an audio “card” that can convert digital data to audio signals. The memory 120 can be in various forms including RAM, ROM, disk, and flash memories. The switch can be configured in various ways, e.g., push, toggle, slide, etc., to conform to the operations detailed below. The system 100 can be hand-held, or mounted in a vehicle. The connections can be wireless.

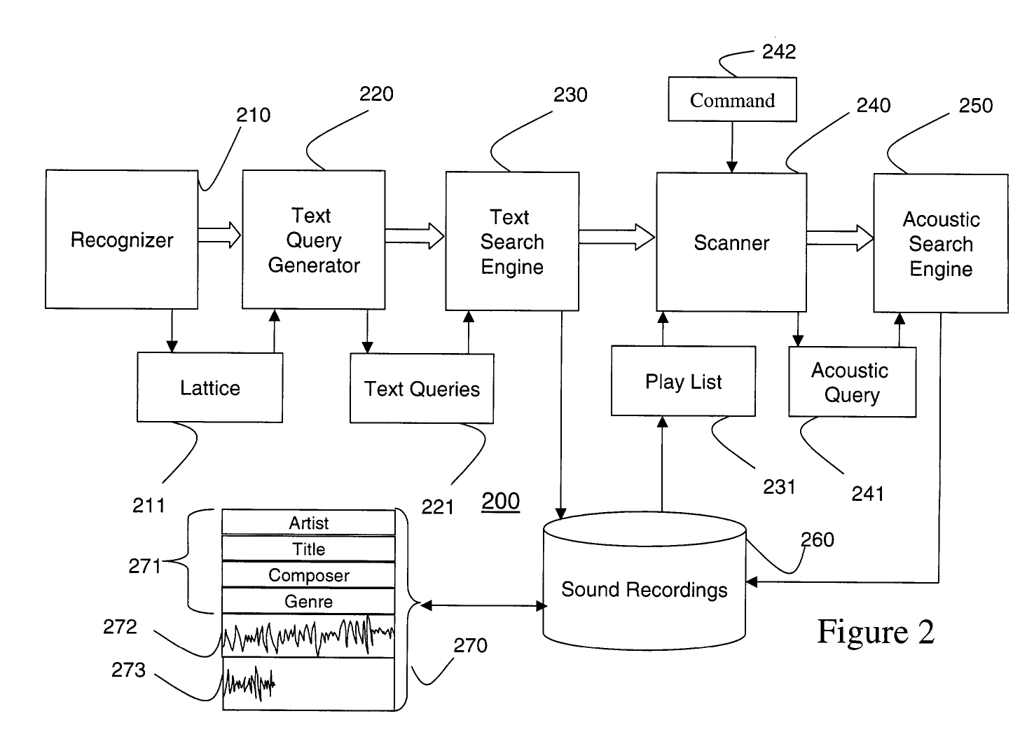

FIG. 2 shows additional details of the system 100, including a speech recognizer 210, a text query generator 220, a text search engine 230, a scanner 240 and an acoustic search engine 250. These are implemented by software modules stored in the memory 120 and executed by the processor 110.

The memory 120 also stores a database 260 of records 270. Each record 270 includes associated text descriptors 271, an audio recording 272, and a sample 273 of the recording 272. The switch 140 and the microphone 130 provide input to the recognizer 210 and the scanner 240. The speaker 150 plays samples and recordings as selected by the user. The speaker can also be used to provide system status information.

System Operation

As shown in a method 200 in FIG. 2, the recognizer 210 receives a spoken user query via the microphone 130. The switch 140 can be used to actuate the microphone. The recognizer 210 represents the spoken query as a phonetic lattice 211. Nodes in the lattice represent phonetic primitives, such as words, syllables, or phonemes, and edges indicate possible sequences of the primitives.

The text query generator 220 converts the lattice 211 into a set of text queries 221 representing the paths through the lattice as likely textual representations of the spoken query, see, Wolf, et al., U.S. patent application Ser. No. 10/132,753, “Retrieving Documents with Spoken Queries,” filed on Apr. 25, 2002 and incorporated herein by reference in its entirety.

The text search engine 230 searches the records 270 in the database 260 to generate a play list 231 by comparing the text queries 221 to the text descriptors 271 of each record 270. The play list indicates records having text descriptors matching the text query 221. The play list can be ordered according text descriptors, a certainty of the text query, or a random order.

The scanner 240 plays the sample 273 of each record 270 in the order of the play list 231 using the speaker 150. The user can select a sample from the play list by inputting a command 242 using the microphone 130 or the switch 140. The command either plays the corresponding recording 272 or updates the play list.

To update the play list, the selected sample forms an acoustic query 241. The acoustic search engine 250 searches the records 270 and updates the play list with records 270 matching the acoustic query 241, see, Casey, U.S. patent application Ser. No. 09/861,808, “Method and System for Recognizing, Indexing, and Searching Acoustic Signals,” filed on May 21, 2001 and incorporated herein by reference in its entirety. Again, the play list 231 can be ordered or random.

The scanner 240 can then play the samples of the recordings in the updated play list 231. Alternatively, the user can issue a command to the scanner, using the microphone or the switch, to play any or each recording indicated by the updated play list in any order.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for selecting recordings from a database stored in a memory, comprising:
representing a spoken query as a phonetic lattice;
converting paths through the phonetic lattice to a set of text queries;
searching the database to generate a playlist of recordings matching the set of text queries;
playing samples of the recordings on the playlist; and
selecting a particular sample as an acoustic query;
searching the database to update the playlist with recordings matching the acoustic query;
playing samples of the recording on the updated playlist; and
selecting a particular sample of the updated play list to play a particular associated recording.

2. The method of claim 1 further comprising:
maintaining records in the database, each record including a recording, a sample of the recording and associated text descriptors.

3. The method of claim 2 wherein the step of searching the database to generate the playlist further comprises:
comparing the set of text queries with the associated text descriptors in each record; and
identifying records having associated text descriptors that match the set of text queries.

4. The method of claim 2, further comprising:
ordering the playlist according to the text descriptors.

5. The method of claim 2, further comprising:
ordering the playlist according to a certainty of the text query.

6. The method of claim 2, further comprising:
ordering the playlist according to a random order.

7. The method of claim 1 wherein the steps of selecting are initiated in response to a command.

8. The method of claim 7 wherein the command is a spoken command.

9. The method of claim 7 wherein the command is input mechanically.

10. An apparatus for selecting recordings from a database stored in a memory, comprising:
a speech recognizer for representing a spoken query as a phonetic lattice;
means for converting paths through the phonetic lattice to a set of text queries;
means for searching the database to generate a playlist of recordings matching the set of text queries;
a scanner for playing samples of the recordings on the playlist, the scanner including a speaker;
means for updating the playlist with recordings in the database matching an acoustic query; and
means for selecting a particular sample from the playlist, having two modes, in a first mode, said means is capable of selecting a particular sample as the acoustic query, and in a second mode said means is capable of selecting a particular sample associated with a recording in the database matching the acoustic query.

11. The apparatus of claim 10 wherein a connection with the memory is wireless.
